(19) United States
(12) Patent Application Publication
(10) Pub. No.: US 2022/0003362 A1
(43) Pub. Date: Jan. 6, 2022

(54) HYDROGEN TANK AND HYDROGEN PIPE THAT ARE COVERED WITH A TWO-DIMENSIONAL MATERIAL, AND PLANT FOR DELIVERING HYDROGEN

(71) Applicant: Airbus SAS, BLAGNAC (FR)

(72) Inventor: Richard Forster, Blagnac (FR)

(21) Appl. No.: 17/356,944

(22) Filed: Jun. 24, 2021

(30) Foreign Application Priority Data
Jul. 2, 2020 (FR) 2006995

(51) Int. Cl. F17C 13/00; F16L 9/147

(52) U.S. Cl. CPC F17C 13/00; F16L 9/147; F17C 2201/035; F17C 2203/03; F17C 2265/068; F17C 2203/0648; F17C 2221/012; F17C 2260/036; F17C 2203/0607

(57) ABSTRACT

A plant for delivering hydrogen includes a hydrogen tank and at least one pipe for delivering hydrogen. At least one surface of the hydrogen tank or of the hydrogen delivery pipe is covered with a two-dimensional material mixed with a polydopamine-type polymer.

### CROSS-REFERENCES TO RELATED APPLICATIONS

This application claims the benefit of the French patent application No. 2006995 filed on Jul. 2, 2020, the entire disclosures of which are incorporated herein by way of reference.

### FIELD OF THE INVENTION

The invention relates to the field of the delivery of hydrogen between a hydrogen tank and a hydrogen consumer such as for example an engine or a fuel cell.

### BACKGROUND OF THE INVENTION

The hydrogen is generally stored in a tank in its dihydrogen (H2) form, in the liquid state or in the gaseous state Similarly, it may be transferred from the tank to the consumer in the liquid state or in the gaseous state, by means of one or more hydrogen delivery pipes. The tank and the delivery pipes are generally of metallic type. It is known that, given the small dimensions of the hydrogen molecules (H2), these molecules have a tendency to leak through the walls of the tank or of the delivery pipes, in particular at the welds. It is known to use barrier layers to coat the tank or the hydrogen delivery pipes to reduce the leaks. However, the effectiveness of the barrier layers is not perfect. Consequently, to avoid a risk of explosion, it is necessary to provide either a ventilation system for discharging the hydrogen leaks, or a system for neutralizing the hydrogen by mixing with nitrogen. However, such ventilation or neutralization systems have the drawback of increasing the weight of the hydrogen delivery plant, which it is desired to avoid, in particular when the hydrogen delivery plant is installed on an aircraft.

Furthermore, leaks of hydrogen through the walls of the tank or of the delivery pipes may give rise to a phenomenon of hydrogen embrittlement which may lead to a deterioration of the tank or of the delivery pipes.

### SUMMARY OF THE INVENTION

One objective of the present invention is, in particular, to provide a solution to these problems. It relates to a plant for delivering hydrogen to at least one hydrogen consumer, the plant comprising a hydrogen tank and at least one pipe for delivering hydrogen, characterized in that at least one surface of the hydrogen tank or of the at least one hydrogen delivery pipe is covered with a two-dimensional material mixed with a polydopamine-type polymer.

The two-dimensional material forms a barrier preventing the passage of gases such as hydrogen. Thus, the surface covered by the two-dimensional material has the advantage of being leaktight to the passage of hydrogen, which makes it possible to prevent leaks of hydrogen through the walls of the hydrogen tank or of the hydrogen delivery pipes. Furthermore, a polydopamine-type polymer has the advantage of having high properties of adhesion to a surface to which it is applied. Consequently, the fact of mixing the two-dimensional material with such a polymer makes it possible to improve the adhesion properties of the two-dimensional material to the surface of the tank or of the pipe covered by this two-dimensional material.

According to various embodiments that can be taken separately or in combination:

the at least one surface corresponds to an internal surface of the hydrogen tank or of the at least one hydrogen delivery pipe;

the at least one surface corresponds to an external surface of the hydrogen tank or of the at least one hydrogen delivery pipe;

the two-dimensional material is chosen from the following two-dimensional materials:

graphene;

graphene oxide;

HBN (Hexagonal Boron Nitride);

the two-dimensional material is mixed with a polydopamine-type polymer;

the two-dimensional material is mixed with the polydopamine-type polymer in the form of platelets, in a weight proportion of between 0.5% and 2%;

the mixture of the two-dimensional material and of the polydopamine-type polymer forms a layer having a thickness of less than 500 micrometers on the surface of the hydrogen tank or of the at least one hydrogen delivery pipe.

The invention also relates to a hydrogen tank comprising at least one surface covered with a two-dimensional material.

The invention also relates to a hydrogen delivery pipe comprising at least one surface covered with a two-dimensional material.

### BRIEF DESCRIPTION OF THE DRAWINGS

The invention will be better understood on reading the following description and on examining the appended figures.

FIG. 1A schematically illustrates a hydrogen delivery plant in accordance with one embodiment of the invention.

FIG. 1B is a detail view of a zone Z from FIG. 1A.

### DETAILED DESCRIPTION OF THE PREFERRED EMBODIMENTS

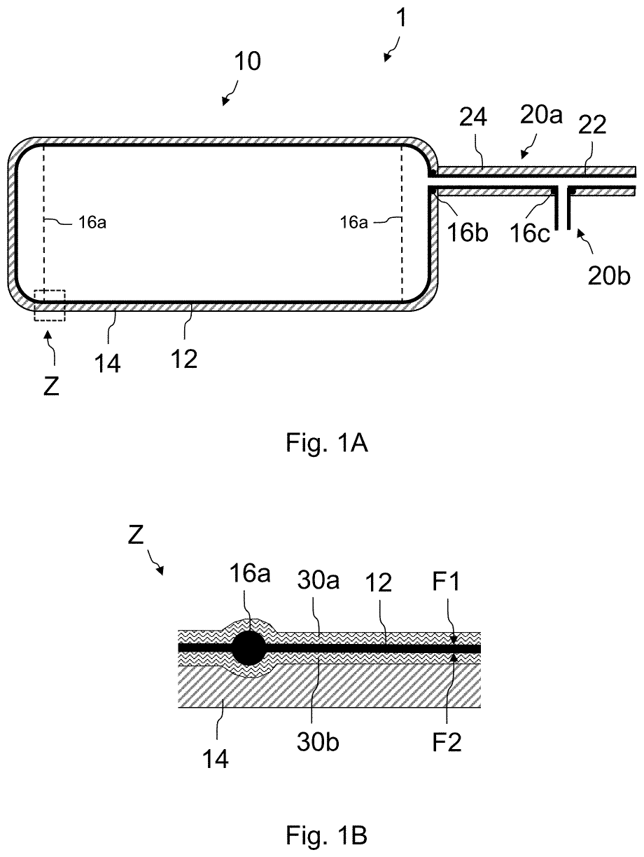

The hydrogen delivery plant 1 represented in FIG. 1A comprises a hydrogen tank 10 and a set of hydrogen delivery pipes 20a, 20b. The hydrogen tank 10 comprises a casing 12, several parts of which are joined together by means of welds 16a. According to a first alternative, the casing 12 is metallic. According to a second alternative, the casing 12 is made from composite material. The hydrogen delivery pipe 20a comprises a tube 22 welded to the hydrogen tank 10 by means of a weld 16b. The tube 22 is, for example, made from the same material as that used for the casing 12 of the hydrogen tank. The hydrogen delivery pipe 20b also comprises a tube, welded to the tube 22 of the hydrogen delivery pipe 20a by means of a weld 16c. The hydrogen tank 10 is covered, on the outside, by a layer of thermal insulation 14 Similarly, the hydrogen delivery pipe 20a is covered, on the outside, by a layer of thermal insulation 24.

The casing 12 of the hydrogen tank comprises a first face F1 inside the tank and a second face F2 outside the tank. The surface of at least one from among the first face F1 and the second face F2 is covered with a two-dimensional material. In the example illustrated in FIG. 1B, the surface of the first face F1 is covered with a two-dimensional material 30a and the surface of the second face F2 is covered with a two-dimensional material 30b. The two-dimensional material 30a and/or 30b also covers the welds 16a.

Preferably, the tubes of the hydrogen pipes, such as the tube 22 of the hydrogen pipe 20a, also comprise at least one surface covered with a two-dimensional material. Just like for the tank 10, this surface of the tube of the hydrogen pipe may be an internal surface of the tube or an external surface of the tube. The two-dimensional material also covers the welds 16b and 16c.

The two-dimensional material 30a, 30b forms a barrier preventing the passage of hydrogen. Thus, the surface covered by the two-dimensional material has the advantage of being leaktight to the passage of hydrogen, which makes it possible to prevent hydrogen leaks through the casing 12 of the hydrogen tank or through the tubes 22 of the hydrogen delivery pipes.

The two-dimensional material is for example chosen from the following two-dimensional materials:

graphene;

graphene oxide;

HBN (Hexagonal Boron Nitride).

These examples of two-dimensional materials do not, however, limit the invention. Other two-dimensional materials may be employed if they are impermeable to hydrogen.

Graphene and HBN have the advantage of being impermeable both to hydrogen and to water and water vapor. Graphene oxide is impermeable to hydrogen, but not to water vapor. Consequently, given that the hydrogen contained in the hydrogen tank or in the pipes is not generally absolutely pure, but that it may be mixed with water vapor, graphene and HBN may be used irrespective of the form, liquid or gaseous, in which the hydrogen is stored in the tank 10 or circulates in the delivery pipes 20a, 20b. When the hydrogen is stored in the tank 10 or circulates in the delivery pipes 20a, 20b in liquid form, graphene oxide may also be used as two-dimensional material since water cannot be in the vapor state or in the liquid state, but only in the solid state, for the temperatures at which hydrogen is in the liquid state.

Advantageously, the two-dimensional material is mixed with a polymer of polydopamine type, also referred to as PDA. Such a polymer has the advantage of having high properties of adhesion to a surface to which it is applied. Consequently, the fact of mixing the two-dimensional material with such a polymer makes it possible to improve the adhesion properties of the two-dimensional material to a surface of the tank or of a pipe covered by this two-dimensional material.

The two-dimensional material is, for example, mixed with the polydopamine-type polymer in the form of platelets. In one particular embodiment, the weight proportion of the two-dimensional material (for example HBN) in the mixture is between 0.5% and 2%.

In a further particular embodiment, the mixture of the two-dimensional material and of the polydopamine-type polymer forms a layer having a thickness of less than 500 micrometers on the surface of the hydrogen tank or of the hydrogen delivery pipe to which it is applied.

The mixture of the two-dimensional material, for example HBN, and of the polydopamine-type polymer can be applied to the surface of the tank or of the pipe in various ways, for example: spraying, brush, soaking, inkjet printing, etc. Thus, this mixture is easy to apply to this surface, including to the welds 16a, 16b, 16c. Consequently, the invention makes it possible to protect the whole of the tank and/or of the hydrogen delivery pipes, including the weld zones which are generally the most susceptible to hydrogen leaks.

When the mixture of the two-dimensional material, for example HBN, and of the polydopamine-type polymer is applied to the surface of the exterior face F2 of the hydrogen tank (or of the hydrogen delivery pipes), the adhesive properties of the polydopamine-type polymer make it possible to facilitate the adhesion, onto this surface, of the thermal insulation 14 or 24.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A plant for delivering hydrogen to at least one hydrogen consumer, said plant comprising:
a hydrogen tank, and
at least one pipe for delivering hydrogen,
at least one surface of the hydrogen tank or of said at least one hydrogen delivery pipe being covered with a two-dimensional material,
wherein the two-dimensional material is mixed with a polydopamine-type polymer to form a mixture.

2. The plant according to claim 1, wherein said at least one surface corresponds to an internal surface of the hydrogen tank.

3. The plant according to claim 1, wherein said at least one surface corresponds to internal surface of said at least one hydrogen delivery pipe.

4. The plant according to claim 1, wherein said at least one surface corresponds to an external surface of the hydrogen tank.

5. The plant according to claim 1, wherein said at least one surface corresponds to an external surface of said at least one hydrogen delivery pipe.

6. The plant according to claim 1, wherein the two-dimensional material is chosen from the following two-dimensional materials:
graphene;
graphene oxide;
HBN (Hexagonal Boron Nitride).

7. The plant according to claim 1, wherein the two-dimensional material is mixed with the polydopamine-type polymer in a platelet form, in a weight proportion of between 0.5% and 2%.

8. The plant according to claim 1, wherein the mixture of the two-dimensional material and of the polydopamine-type polymer forms a layer having a thickness of less than 500 micrometers on said at least one surface of the hydrogen tank or of said at least one hydrogen delivery pipe.

9. A hydrogen tank comprising at least one surface covered with a two-dimensional material mixed with a polydopamine-type polymer.

10. A hydrogen delivery pipe comprising at least one surface covered with a two-dimensional material mixed with a polydopamine-type polymer.
